(19) United States
(12) Patent Application Publication
(10) Pub. No.: US 2007/0144360 A1
(43) Pub. Date: Jun. 28, 2007

(54) MULTIPLE PRESS WITH ADJUSTABLE SPACINGS

(76) Inventor: Christian Heichel, Niedernberg (DE)

Correspondence Address: EDWIN D. SCHINDLER, FIVE HIRSCH AVENUE, P.O. BOX 966, CORAM, NY, 11727-0966, US

(21) Appl. No.: 11/608,938

(22) Filed: Dec. 11, 2006

(30) Foreign Application Priority Data
Dec. 15, 2005 (DE) 102005060418.8

(51) Int. Cl. B30B 7/00

(52) U.S. Cl. 100/137

(57) ABSTRACT

A multiple press with adjustable spacings includes at least three press units disposed parallel to one another and a common horizontally disposed rail with each press unit being displaceable on the common horizontally disposed rail, along with a drive mechanism, with at least two press units press units being connected to one another by way of the drive mechanism. Each press unit includes a ram that is able to be displaced in a vertical guide by way of a hydraulic cylinder and with a collet on a lower face of the ram.

### BACKGROUND OF THE INVENTION

1. Technical Field of the Invention

The invention relates to a multiple press for driving and extracting metal sheet-pile profiles into and out of the ground, comprising at least three press units disposed parallel to one another, including a ram, which is displaceable in a vertical guide via a hydraulic cylinder, and has a collet on the lower end face thereof.

2. Description of the Prior Art

Presses for driving and extracting individual metal profiles of sheet-pile walls, which are connected on one another via so-called “locks,” namely interlocking profile edges, have long been known in the prior art. German Patent No. 3 815 748 describes an arrangement comprising at least three press units, of which each exerts either only a static force and/or a vibrational, pulsational or impact movement. This patent also describes the connection of the press units to the individual metal profiles via a collet.

An important part of this prior art arrangement, however, is the fact that the distances between the individual press units must be fixed during construction. Only when the width of the metal profiles of the sheet-pile wall corresponds exactly to the distances between the press units can the entire press be mounted on the sheet-pile walls, such that each collet engages in the center of the individual profile. Only in this position is the formation of tilting moments avoided, which lead to adjacent profiles be able to jam in one another and, consequently, only being capable of being rammed in with increased force exertion up to a possible deformation of the lock between the profiles.

Another serious disadvantage is that the collet can only grip those sections of all metal profiles that are arranged aligned in a common plane. Such a press is therefore only suitable for a few profiled, predominantly planar sheet-pile walls. For some applications, however, Z-shaped profiles are far more advantageous, since they result in a very deep-profiled and therefore very stiff sheet-pile wall. However, according to the prior art, these profiles can only be rammed individually into the earth, that is to say a plurality of profiled must be processed in succession.

### SUMMARY OF THE INVENTION

Against this background, it is the object of the invention to develop a multiple press, which, for any width of sheet-pile profile, permits the collets to be set in the center of the profile and the collets to be adjustable to the inclined position of the profile with respect to the center plane of the sheet-pile wall.

To this end, the invention proposes a multiple press comprising at least two press units, in which every press unit can be displaced on a horizontally arranged rail and at least two press units are connected to one another by means of a drive mechanism.

The press units themselves are known in the prior art. It is novel that they are arranged so as to be slidable on a common horizontal rail. To this end, it is proposed that groove-shaped attachments on each press unit engage around the horizontal rail from above as well as from below, that is to say form, in principle, a C-shaped structure with which the press units are displaceable on the rail. In dimensioning the groove and rail, it is to be noted that the press units must not only apply forces in a vertical direction but, as a result of inhomogeneities in the ground and as a result of possible contamination in the lock of the metal profiles, must compensate for tilting moments that are oriented transversely to the longitudinal axis of the press units. These tilting moments must be transmitted by the horizontal rail and by the suspension thereon. The rail must in turn, again according to the prior art, be connected to a central suspension.

The gist of the invention is that the distances between the individual press units can be adjusted. Here, the invention prefers drive mechanisms for the adjustment unit in which it is ensured that the distances between the individual press units are always the same. That is highly advisable if the sheet-pile wall consists of profiles of the same width. In an additional embodiment, it is conceivable that profiles of different widths alternate in a repeating rhythm along the sheet-pile wall. For this special case, it is advisable to provide between the drive mechanism and the individual press units, a further, at least mechanical adjustment means, which by remote control displaces an individual press unit with respect to the entire drive mechanism.

Since, in practice, predominantly sheet-pile profiles of the same width are installed, the multiple press according to the invention is a decisive advance as regards the uniformity of force application and as regards displacement of the metal profiles with respect to one another in a way that is gentle on the lock. The reduction of the friction in the lock further increases the efficiency of the system and thereby provides even greater power reserves to overcome possible inhomogeneities in the substrate or for forcing aside and/or breaking up stones in the substrate.

### DESCRIPTION OF THE PREFERRED EMBODIMENTS

In a further advantageous embodiment the collet is pivotable about the longitudinal axis of the vertical guide and can be fixed at any angular position. By this means, a reliable, large-area, and therefore load-resistant connection between the collet and metal profile is possible even in the case of Z-shaped profiles. In one embodiment of this variant, the invention proposes, to fix the angular position, that a fixing plate, which is pivotable about the longitudinal axle of the vertical guide, can be pressed into a complementarily-shaped recess at the lower face end of the ram, for example by means of a screwable cover. In the simplest case, for adjustment, the cover is released; the fixing plate is manually rotated to the desired angle and fixed by retightening the screw joint of the cover.

In one variant, it is conceivable that the release of the cover and rotation of the collet can be controlled by means of a hydraulic cylinder and/or hydraulic motors, position actual-value sensors and a remote displace for the securing of the cover being conceivable as a further improvement.

The gist of the invention, however, is the adjustability of the distance between the individual press units, for which purpose a drive mechanism is necessary. For the execution thereof, the invention proposes, in principle, three variants, namely first a threaded spindle with running nut, second scissor-like cooperating levers, and third a pinion and toothed belts or rack or chain.

In the connection of the press units via a threaded spindle, it should be observed that the goal is the adjustment of the distance between the press units, wherein all press units are always required to have the same distance from one another. From this it follows that the travel distance of each individual unit is different.

A conceivable configuration is that a continuous threaded spindle extends from the first press unit to the last press unit, parallel to the travel rail and is fixed in place. For each press unit, a running nut is arranged on the threaded spindle and can be rotated from the press unit and thereby displaces the press unit. The rotational direction of the drive motors on the left-hand side is then opposite to the rotational directions of the drive motors on the right-hand side. Furthermore the travel distance of the outer press units is three times as great as the travel distance of the next, inner press units. These differences must be taken into account by correct actuation of the drives. The control would therefore be comparatively complicated. The only advantage of this arrangement is that sheet-pile profiles of changeable width can always be gripped in the centre by the collets.

In the interest of a simplified and reliable, and therefore forced control of the adjustment movement, the invention prefers that the running nuts of each press unit are not rotatable, but firmly connected to the press unit. Instead of that, the threaded spindle is rotatable, for which purpose, in the simplest case, a single rotating drive is sufficient. In this case the different lengths of the travel distance and the different travel directions are to be taken into account by means of a different value of the pitch and different orientations of the pitch.

In the prior art, it is readily possible to manufacture a continuous threaded spindle on which a plurality of sections with screw threads of different pitch value and different orientation are arranged. However, since such an inhomogeneous threaded spindle has to be specially made, the invention prefers it to be assembled from a plurality of subsections with couplings. Since homogeneous threaded spindles and couplings are readily available from larger series, this construction alternative is probably most cost effective.

A principle advantage of a drive mechanism via threaded spindles is that it takes up a comparatively small space. It is also advantageous that, by virtue of the gear ratio of the spindle, it can be adapted to standardized rotating drives with relatively high speeds, but small torque, and can thereby operate without further intermediate transmissions. That results in savings in size and therefore the costs of each rotating drive.

However, since the travel distances are of limited length, in a further variant, which is also interesting, the drive mechanism is not designed as a threaded spindle but as a scissor mechanism of levers that are connected together in an articulated manner. The principle of levers that are connected to one another in an articulated manner in pairs at their center, and whose ends are connected, also in an articulated manner, to the next pair of levers, has long been known in the prior art.

The new feature is to apply this mechanism to adjusting the distance of press units. The invention prefers the arrangement of the scissor mechanism above the press units in a vertical plane, which is oriented parallel to the travel rail of the press units. In this arrangement, the individual press units are appropriately linked to the lower pivot axes of the scissor mechanism. For each press unit, one scissor lever in each case must be provided. With an even number of press units, the outer scissor levers do not required a pivot axis in their centre; for the inner pairs of press units, however, each pivot lever must also have a pivot axle in the center, which is connected to the center axle of the adjacent lever.

With an odd number of press units, it is sufficient if an inner press unit that is adjacent to one of the two outermost press units has a scissor lever of half length with a pivot axle at each of its ends. The free end of this short pivot lever is rotatably connected to the center point of the adjacent outermost pivot lever.

For the drive of the scissor mechanism, it is possible to mount a rotating drive on one of the pivot axes. However, in comparison to the drive on the threaded axle, this drive must apply a very much higher torque, but also, for a uniform travel velocity of the individual press units, must rotate with only a comparatively very low rotational speed.

Probably the most cost-effective and durable drive is a hydraulic cylinder, which is linked at two points to two adjacent scissor levers. The hydraulic cylinder can be linked both on the pivot axes as well as outside thereof.

A decisive advantage of the scissor mechanism is that they comprise of only a few parts. It is even possible to construct the entire scissor mechanism from identical scissor levers. To this end, with an odd number of press units, it must be taken into account that a single lever has a freely pivoting end that is not connected further.

Another advantage of connecting all scissor levers only via rotating axes is that, according to the prior art, they can be readily protected against external contamination and, designed with ball bearings, have very low internal friction. In the present application case, however, plain bearings are also an economically favorable alternative. All other known forms of rotational bearings are also applicable.

As a third variant for designing the drive mechanism, the invention mentions toothed belts or racks or chains, which combine the individual press units in respective pairs, starting from the outer edges. In order that, the distance between the individual press units is not changed by the adjustment, with this drive variant the toothed belt pulleys, or the pinions for the racks or the chain wheels for chains, differ from one another by a factor of three in each case. The rotational axles of adjacent pairs must be connected together via a common axle.

In this variant, too, it is possible to employ both rotating and linear drives. Since all toothed-belt pulleys are connected to on another via axles, a single rotational drive is sufficient. In comparison to a threaded spindle, however, it should be noted that, for the same travel rate, the required maximum speed of the drive motor is comparatively low, but a relatively high drive torque is required.

For a counter-rotating direction of movement of the press units at the left-hand side in comparison to the direction of movement at the other side, it is necessary for all press units at the left-hand side to be connected respectively to the upper or front side of the toothed belt, or the rack, or the chain. All press units of the right-hand side are then connected to the lower or rear side of the toothed belt.

It is possible for those regions of the toothed belt, of the rack or of the chain that are not in contact with the passing toothed wheels or chain wheels, and regions in which no deflection is necessary, to be replaced with an inflexible material such as a connecting rod. In this case, the toothed belt would not run through homogeneously, but would be repeatedly coupled to mechanical rods. The advantage is smoother running with less vibration.

It is also conceivable to use a very simple design of the drive mechanism, namely a hydraulic cylinder that links two adjacent press units to one another. A disadvantage of this arrangement is that each hydraulic cylinder requires its own valve and with higher requirements on the positioning accuracy also its own position actual-value sensor. By this means the actuation becomes more complicated and susceptible.

In comparison to individual drives, the forced coupled variants with a continuous threaded spindle or a continuous scissor mechanism are simpler and more reliable.

In all drive variants, a position actual-value transmitter can be mounted, via which a control loop can be closed, so that they are only guided to the position, but the reaching of the position is continually interrogated via the sensor and automatically controlled in dependence thereon. In all cases, the use of a linear position actual-value sensor is possible, which in the simplest case is arranged between two adjacent press units.

With a mechanical forced coupling of all press units to the pair equipped with a sensor, the precision of the position control (within the limits of the play in the joints) applies to all press units.

It is, however, also possible to mount a rotating position actual-value sensor. In the case of a threaded spindle, it is appropriate to couple the sensor to the free end of the spindle. In the case of a scissor mechanism, a rotating sensor is mounted on one of the pivot axles. In the case of a toothed belt adjustment, the sensor is flange mounted on one of the axles for the toothed-belt pulleys.

### BRIEF DESCRIPTION OF THE DRAWING FIGURES

Further details and features of the invention are explained below in greater detail with reference to examples. The illustrated examples are not intended to restrict the invention, but only to explain it. In schematic view:

FIG. 1 shows a multiple press with four press units and threaded spindles;

FIG. 2 shows a section through a press unit on a horizontal rail; and,

FIG. 3 shows a forward oblique picture of a multiple press with a scissor lever mechanism.

### DETAILED DESCRIPTION OF THE DRAWING FIGURES AND PREFERRED EMBODIMENTS

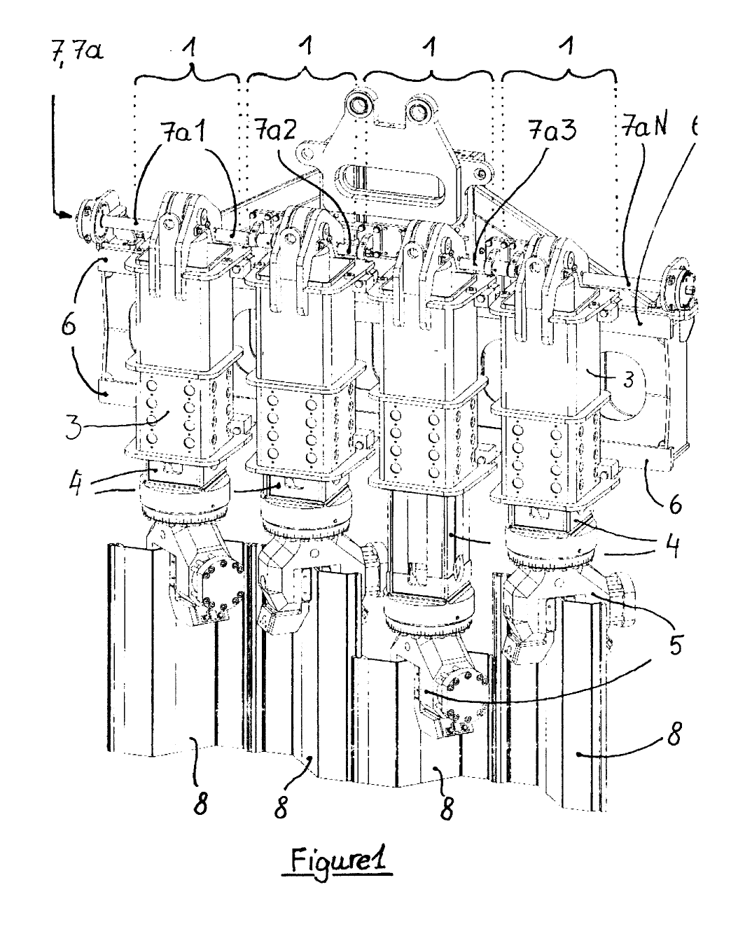

FIG. 1 shows a forward oblique picture of an oblique press with four press units, of which the second from the right is extended as far as the limit stop at the bottom. All four collets 5 are rotated with respect to the main direction of the sheet-pile wall, because the latter comprise of Z-shaped sheet-pile profiles 8.

In FIG. 1, it is made more understandable that a multiple press, according to the invention, also makes possible operation without vibration or pulsation or impacts by the fact that all four press collets are connected to sheet-pile metal profiles 8, but only one press unit is expanded or contracted, while the others are blocked. By this means, only a single profile is displaced; the force necessary for that is diverted via the multiple press to the adjacent metal sheet-pile profiles 8 without loading the carrier of the multiple press. In this mode of operation, the operating noises are much lower than in pulsation operation, which noticeably reduces the acoustic stress on the operating personnel and the environment.

Irrespective of the mode of operation, however, is the adjustment of the individual press units. FIG. 1 shows the adjustment by means of a threaded spindle 7a. For each press unit, a running nut, which is not shown in FIG. 1, is arranged on the threaded spindle 7a.

In the example in FIG. 1, the threaded spindle 7a is subdivided into two sub-spindles; these sub-spindles are in turn divided between the individual press units 1 and connected together via couplings. The left section comprises the threaded spindle sections 7a1 and 7a2. The right-hand section comprises the spindle sections 7a3 and 7aN. In this case N represents the fourth spindle.

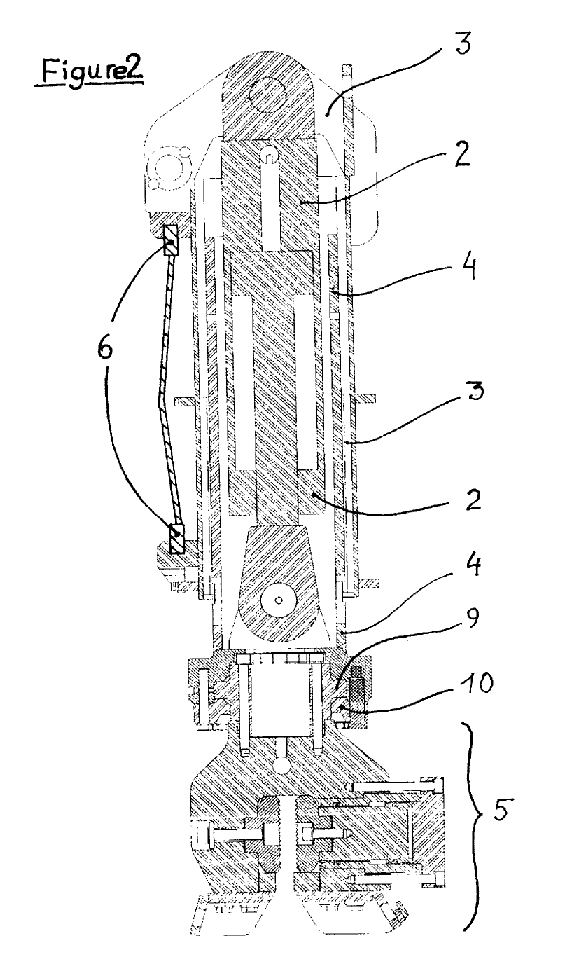

FIG. 2 shows the longitudinal section through a press unit 1, which rests on a rail 6 (which is also shown in section.) It can be seen how attachments are fixed on the body of the vertical guide 3 with a groove, which engage around the rail 6 in a C-shape. In cross-section, the hydraulic cylinder 2 can be seen, which displaces the piston rod upwards or downwards. It thereby moves the ram 4 in the vertical guide 3. At the lower end of the ram 4, the receptacle for the collet 5 can be seen, here in the pivotable variant with the fixing plate 9, which is pressed into a complementary receptacle in the ram 4. FIG. 2 shows a cover 10 for pressing down.

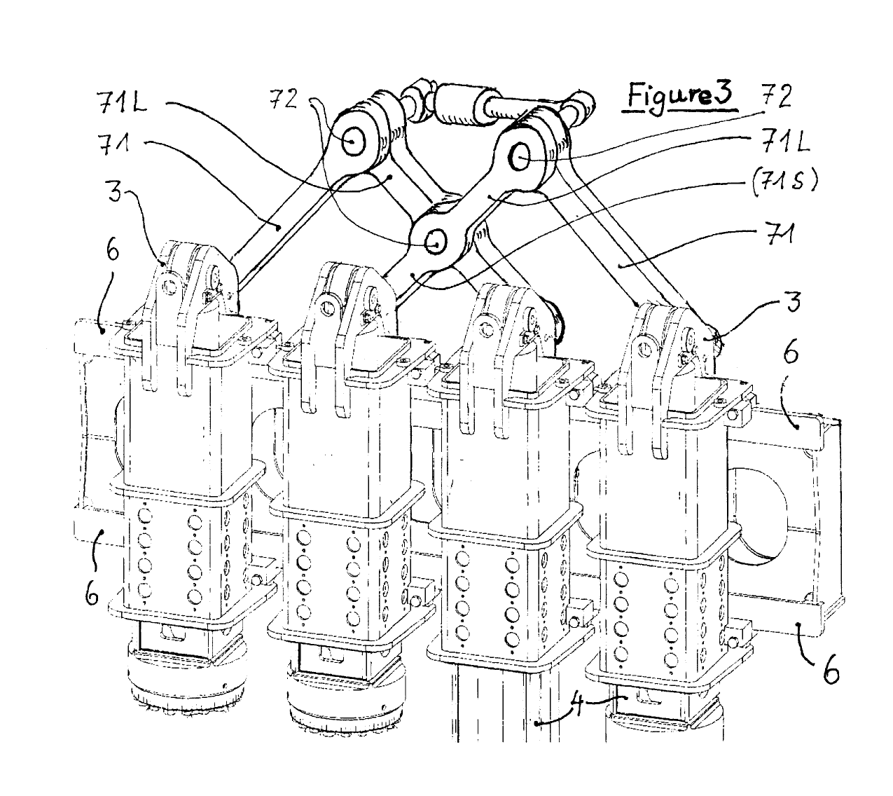

FIG. 3 shows the same press units 1 as in FIG. 1, here, however, with a drive mechanism 7 in the form of a scissor mechanism. With an even number of press units 1 as in FIG. 3, the scissor levers 71 of the two outer press units only have pivot axes at their ends.

The respective inward press units 1 are linked to scissor levers 71 L by means of an additional pivot axis in the center on the joint. The scissor levers 71 L of adjacent inner press units 1 are connected to one another via this center pivot axle.

From FIG. 3 it can be easily derived what the scissor mechanism of an odd number of press units 1 looks like. If, for example, the press unit 1 shown at the far right is not present, its scissor lever 71 is also not present. If the shear lever 71 L, which is halfway exposed, is not to be used with the free pivot axis for linking the drive cylinder, this scissor lever can be halved and thereby becomes a scissor lever 71S of half the length of the scissor lever 71 L. In this variant, comprising three displaceable press units, a hydraulic drive cylinder would suitably engage on the lower pivot axes.

### LIST OF REFERENCE CHARACTERS

1 Press unit
2 Hydraulic cylinder, in press unit 1, moves ram 4
3 Vertical guides, guides the rain 4 vertically
4 Ram, displaceable in the vertical guide 3 by hydraulic cylinder 2
5 Collet on the lower end face of ram 4
6 Rail for horizontal displacement of the press units 1
7 Drive mechanism for displacing the press units 1
7a Threaded spindle, embodiment of the drive mechanism 7
7a1 First threaded-spindle section
7a2 Second threaded-spindle section
7aN Last threaded-spindle section of N threaded-spindle sections
71 Scissor lever, embodiment of the drive mechanism 7
72 Pivot axes of the scissor levers 71
71 S Scissor lever of half the length of the scissor lever 71L
71 L Scissor lever of double the length of the scissor lever 71S
8 Sheet-pile metal profile is clamped around at the top edge by collet 5
9 Fixing plate is pivotable at the lower end face of the ram 4, supports collet 5
10 Cover presses fixing plate 9 into the recess of ram 4

What is claimed is:

1. A multiple press with adjustable spacings, comprising;
at least three press units disposed parallel to one another;
a common horizontally disposed rail with each press unit of said at least three press units being displaceable on said common horizontally disposed rail; and,
a drive mechanism with at least two press units of said at least three press units being connected to one another via said drive mechanism.

2. The multiple press with adjustable spacings according to claim 1, wherein each said press unit includes a ram displaceable in a vertical guide via a hydraulic cylinder and with a collet on a lower face of said ram.

3. The multiple press with adjustable spacings according to claim 2, wherein said collet is pivotable about a longitudinal axis of said vertical guide and is fixable at any angular position.

4. The multiple press with adjustable spacings according to claim 3, further comprising a fixing plate pivotable about said longitudinal axis of said vertical guide for fixing said angular position, said fixing plate able to be pressed into a complementary shaped recess at said lower face of said ram.

5. The multiple press with adjustable spacings according to claim 1, wherein said drive mechanism includes at least one rotatably mounted threaded spindle with sections of different screw pitch and different screw orientation on which, for each said press unit, a respective running nut is displaceable by rotating said threaded spindle.

6. The multiple press with adjustable spacings according to claim 5, wherein said at least three press units include two outer press units and at least one inner press unit, and with a contribution of said different screw pitch of said threaded spindle for running nuts of said two outer press units being three times greater than for running nuts of said at least one inner press unit.

7. The multiple press with adjustable spacings according to claim 6, wherein said running nuts and direction of said screw pitch at a left-hand side of said multiple press are opposite in direction to said running nuts and direction of said screw pitch at said right-hand side of said multiple press.

8. The multiple press with adjustable spacings according to claim 5, wherein each said threaded spindle includes a plurality of mutually coupled threaded spindle sections with each mutually coupled threaded spindle section having a screw pitch that is different.

9. The multiple press with adjustable spacings according to claim 8, wherein each said mutually coupled threaded spindle section is coupled to one another via cross joints and said rail is curved in a horizontal plane.

10. The multiple press with adjustable spacings according to claim 1, wherein said drive mechanism comprises elongated scissor levers connected, in an articulated manner, to one another and to a vertical guide for each ram of each said press unit, said elongated scissor levers being in a vertical plane parallel to said rail with pivot axes of said elongated scissor levers being aligned perpendicular to longitudinal axes of said vertical guide and perpendicular to said rail.

11. The multiple press with adjustable spacings according to claim 10, wherein said at least three press units is three press units with two press units being outer press units and one press unit being an inner press unit, and with one elongated scissor lever of said elongated scissor levers for each said press unit linked to said two outer press units and with two scissor levers being connected in an articulated manner to one another at respective ends, said inner press unit being connected in an articulated manner via an elongated scissor lever to a central point of said two scissor levers.

12. The multiple press with adjustable spacings according to claim 10, wherein said at least three press units is four more said press units with two press units being outer press units and at least two press units being inner press units, and with one elongated scissor lever of said elongated scissor levers being linked to said inner press units with a center point of said one elongated scissor lever being connected in an articulated manner from an adjacent said inner press unit to the center point of said one elongated scissor.

13. The multiple press with adjustable spacings according to claim 10, further comprising a linear drive connected to a point on two adjacent elongated scissor levers of said plurality of elongated scissor levers in an articulated manner.

14. The multiple press with adjustable spacings according to claim 1, wherein said at least three press units includes two outermost press units and said drive mechanism includes a plurality of toothed belts extending parallel to one another and to said rail, said two outermost press units being connected to a first toothed belt of said plurality of toothed belts, and a second toothed belt being connected to an inner press unit of said at least three press units.

15. The multiple press with adjustable spacings according to claim 1, wherein said drive mechanism is movable via a rotating drive having an axle of rotation.

16. The multiple press with adjustable spacings according to claim 1, wherein said drive mechanism is a linear drive.

17. The multiple press with adjustable spacings according to claim 16, wherein said linear drive is a hydraulic cylinder.

18. The multiple press with adjustable spacings according to claim 1, further comprising a linear position actual-value sensor located between two adjacent said press units.
